(19) United States
(12) Patent Application Publication
(10) Pub. No.: US 2006/0034161 A1
(43) Pub. Date: Feb. 16, 2006

(54) Watch

(75) Inventor: Peter A Muller, Gattikon (CH)

Correspondence Address: OLIFF & BERRIDGE, PLC, P.O. BOX 19928, ALEXANDRIA, VA, 22320, US

(73) Assignee: SUPRAVENTURES AG, Luxembourg (LU)

(21) Appl. No.: 10/527,813

(22) PCT Filed: Sep. 25, 2003
(86) PCT No.: PCT/IB03/04211

§ 371 Date: Mar. 30, 2005

(30) Foreign Application Priority Data
Sep. 26, 2002 (CH) 2002 1621/02

(51) Int. Cl. G04B 37/00; G04C 17/00

(52) U.S. Cl. 368/281; 368/223

(57) ABSTRACT

Watch (1), comprising a case (2, 7), at least one watch movement (13, 14) located in the case, and at least one display (3, 4) to display the time of day or other information, wherein at least one section of the watch (7) is movable, specifically, rotatable, wherein the case is composed of an outer case (2) and an inner case (7), and the inner case (7) is movably attached to the outer case, as a result of which a previously nonvisible side of the movable inner case (7) of the watch moves so as to lie on top. The at least one display (3, 4) is located on the inner case, and the inner case (7) is able to fold out of the outer case (2) so that at least one additional laterally oriented display (6) is visible.

### TECHNICAL FIELD

The invention relates to a watch as specified in the preamble of the first claim.

### PRIOR ART

A watch was disclosed in EP 562 522 A1 which folds open and can then be rotated by 180° so as to be re-locked within a frame on which the straps are attached. A watch of this type has only one face, with the result that the time on the watch can be read only in one position, while the possibly ornamented base of the case is visible in the other position. Due to the rotational 180° movement, the watch can also only be read properly in the final position.

U.S. Pat. No. 4,493,561 discloses a watch having two opposing faces. A watch of this type is essentially composed of two watch movements which are attached in an opposing configuration. The resulting case is rotatable about an axis which runs parallel to the longitudinal axis of the watch strap. The individual mechanical watch movements are operatable independently of each other by means of one crown associated with each watch movement. This design is relatively complex and costly, and requires that the watch have a relatively large overall height.

In order to access the second set of information on the opposite face—for example, a second time zone—the watch must always be awkwardly turned completely around.

### DESCRIPTION OF THE INVENTION

The goal of the invention is to avoid the know disadvantages of a watch of the type referenced in the introduction and to provide a reversible watch in which additional information not available on the visible display can be quickly accessed.

This goal is achieved according to the invention through the features specified in the first claim.

The core of the invention thus consist in the fact that the at least one display is located on the inner case and that the inner case is able to fold out of the outer case, and that at least one laterally oriented display is visible.

The advantages of the invention consist, among other things, in the fact that the user has rapid access to additional information through the lateral display without the user's needing to rotate the watch in a complicated maneuver, as is the case with known conventional reversible watches having two opposing displays. Another advantage of the lateral display is that the lateral display allows the wearer of the watch to read off information from the display without rotating his/her arm from its natural position.

Additional advantageous embodiments of the invention are described in the subclaims.

### SHORT DESCRIPTION OF THE DRAWINGS

The following discussion explains embodiments of the invention in more detail based on the drawings. Identical elements in the various drawings are marked with the same reference symbols. The direction of motion for the elements is indicated by arrows.

FIG. 1 is a side view of the watch according to the invention in the folded-shut state;

FIG. 2 is a side view of the watch according to the invention in a partially unfolded state and in a state rotated relative to that of FIG. 1;

FIG. 3A is a top view of the display side of a watch according to the invention in the folded-shut state;

FIG. 3B is a top view of the display side of a watch according to the invention in the partially folded-open state;

FIG. 3C is a top view of a watch according to the invention in a further folded-open state, the second display side;

FIG. 3D is a top view of a watch according to the invention in the completely folded-open state and rotated by 90°;

FIG. 3E is a top view of the other side of the display on a watch according to the invention in the partially folded-upon state and rotated by 180° relative to the orientation of FIG. 3A;

FIG. 3F is a to view of the other side of the display on a watch according to the invention in the folded-shut state;

FIG. 4A is a partial cross-section of a watch according to the invention with a device for turning on and off the displays;

FIG. 4B is a partial longitudinal section through a watch according to the invention from FIG. 4A in the partially folded-open state;

FIG. 4C is a partial cross-section of a watch according to the invention with a device for turning on and off the displays—the other side of the display visible;

FIG. 4D is a partial longitudinal section through a watch according to the invention from FIG. 4C in the partially folded-open state—rotated and the other side of the display;

FIG. 5 is a cross-section through a watch case with crown and push-buttons;

FIG. 6 is a detail of the crown from FIG. 5;

FIG. 7 is a cross-section through a watch case with crown and push-buttons in yet another embodiment;

FIG. 8 is a side view of the actuating mechanism of FIG. 7;

FIG. 9 shows an installation diagram for a battery;

FIG. 10 is a side view of another embodiment of the watch according to the invention in the folded-open state.

Only those elements immediately necessary to understand the invention are shown.

### METHOD OF IMPLEMENTING THE INVENTION

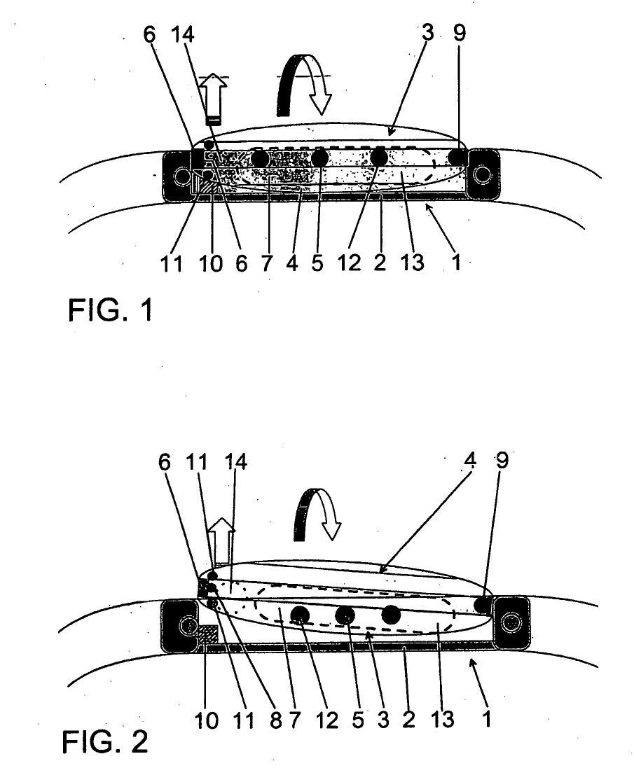

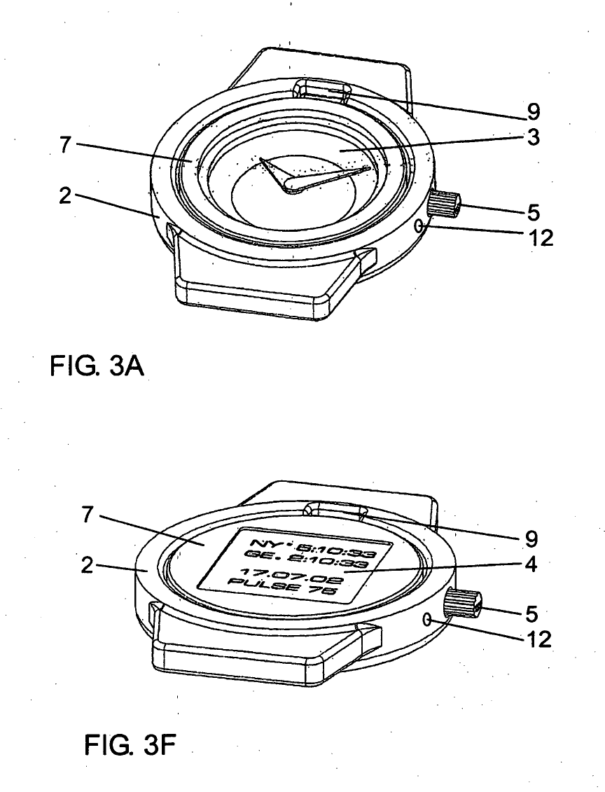

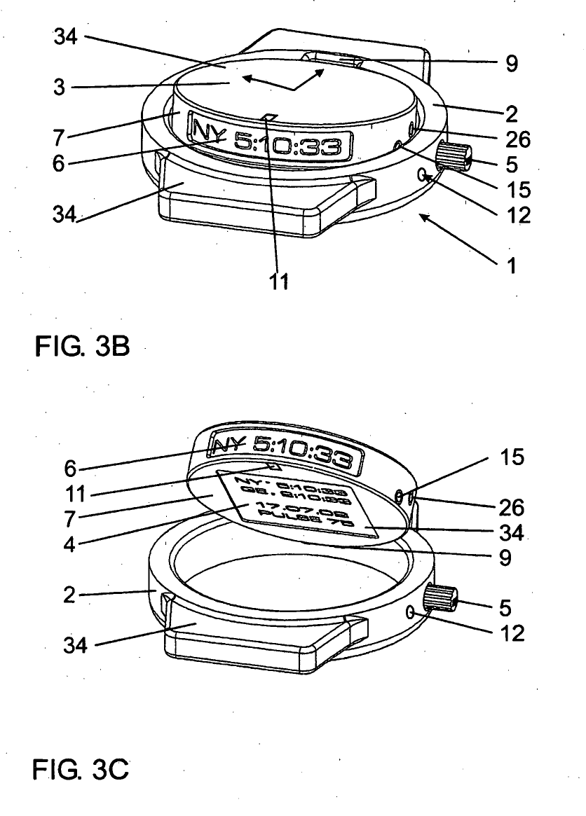

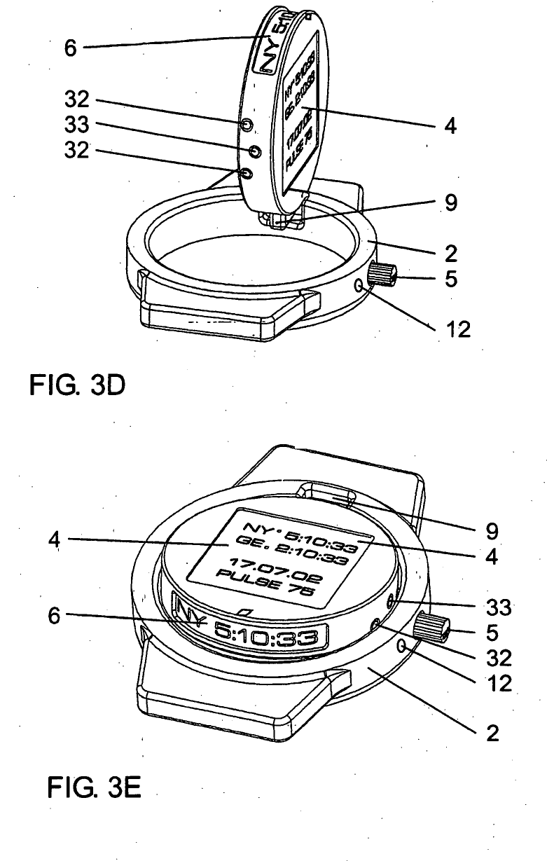

FIGS. 1 and 2 show a watch 1 with a first watch case 2, a first face 3, and a second face 4. In FIG. 3A, face 3 is, for example, an analog display with hands; in FIG. 3F, face 4 is a digital display; analog display 3 may also be replaced by a digital display, and the digital display may be replaced by an analog display or a combination thereof. Located on the side of first watch case 2 is a crown 5 to set the time of day, or other watch functions such as the date.

The watch is able to be folded open, and for this reason the watch movement is located in a second inner case 7; see also FIGS. 3A through 3F. The crown here is located in a first case 2 and does not move together with the second case 7. The action of folding open the inner case can be performed either manually or electronically by, for example, actuating the crown or a push-button 12.

Second inner watch case 7 is connected to first outer case 2 through a pivot 9. The pivot is designed so as to allow the inner case to be folded out of the outer case based on the fold-open motion. Detents, not shown, by which inner case 7 is retained in a position in which an optimal view of a lateral display 6 described in detail below is provided, are located on pivot 9, or between outer case 2 and inner case 7. Additional detents enabling intermediate-stage locking in the folded-out position may be provided. The folding-open action is performed by an ejection element 10 which may consist, for example, of a spring. Located on the bottom section of inner case 7 is a locking element 11 which locks inner case 7 within outer case 2 when inner case 7 is pressed down into outer case 2. Locking may be effected mechanically or electronically by the crown, or by additional push-buttons 12 located on the watch in outer case 2, or by a locking button not shown, or by the pressing inner case into outer case. After folding outward, the inner case is rotated 180° and folded back into the outer case, then once again locked by the locking element 11, also located here, in an approach already known, for example, from the prior art referenced in the introduction The nonvisible display is kept de-energized in order to save power.

Crown 5 and push-buttons 12 may also be attached in the conventional manner to inner case 7 such that outer case 2 only has the function of: accommodating the folding mechanism along with pivot 9 and ejection element 10, enabling inner case 7 to lock 11 in the outer case, and attaching the strap to outer case 2.

The watch is able to be folded open, thereby enabling the third, lateral display 6 to become visible. Lateral display 6 enables the wearer of watch 1 to read off information from the display without rotating his/her arm from its natural position. The information shown on the display may include a second time zone, an alarm, an appointment, a detailed SMS, etc. The fold-open action of the display can occur as a result of a predefined event, corresponding to one of the previously mentioned examples, or manually as described above. As long as lateral display 6 is not visible, the display is kept de-energized to save power. In the folded-open section of inner case 7, additional push-buttons 8 can be located by which functions of the later display can be selected, brought up, or modified. When the inner case is turned around so as to show the other display side 3 or 4, the lateral display text and numbers also rotate, thereby allowing lateral display 6 to be read at all times.

FIGS. 3A through 3F additionally shows how displays 3 or 4 turn around in a manner analogous to the above-described display 6, thereby always being optimally visible to the wearer. As illustrated in FIG. 3C, folding open inner case 7 activates display 4, i.e., the digital display is energized and thus becomes readable. In the case of an analog display with stepper motors, the hands are again moved to the position indicating the correct time. In response the actions of reversing inner case 7, see FIG. 3D, and folding it down to the lower detent position, see FIG. 3E, the text and numbers of display 6 and display 4 rotate 180° so that the wearer of the watch can read display 4 in the normal fashion, i.e., the text and the numbers are no longer upside down for the viewer. The same occurs for the now covered display 3 when the display is turned back. When folded open as in FIG. 3C, display 3 is similarly rendered correctly for the viewer such that the hands are not upside down.

Display rotation is thus also possible for an analog display with a stepper-motor-based watch mechanism, however, the hour markings should then not be provided with permanently applied numbers.

The folding-open motion can also be performed electrically, for example, by an alarm, an incoming SMS, etc. The push-buttons 12 located in the outer case could be used for additional watch functions, such as those in known chronometers, such as a stopwatch timing, setting alarms, etc. If the push-buttons and the crown actuate the watch functions through electrical contacts, the contacting is performed by push-buttons, and possibly by the crown through wires running to watch movement 13. As a result, the functions of the push-buttons can also be performed in the folded-open state. Watch movement 13 may be either electronic or mechanical. In the case of an electronic watch movement, the lateral display can be controlled directly through this electronic watch movement, as can horizontal displays 3 and 4 as well; if hands are used, these are driven by stepper motors. If a mechanical watch movement is used, a second electronic watch movement 14 is located in inner case 7 to control the lateral display, or possibly one of the two horizontal displays 3 or 4. If a mechanical watch movement is used, crown 5 is used to set the usual watch functions; the push-buttons can have a dual function, that is, act on the mechanical watch movement mechanically, and act electronically on the displays through sensors.

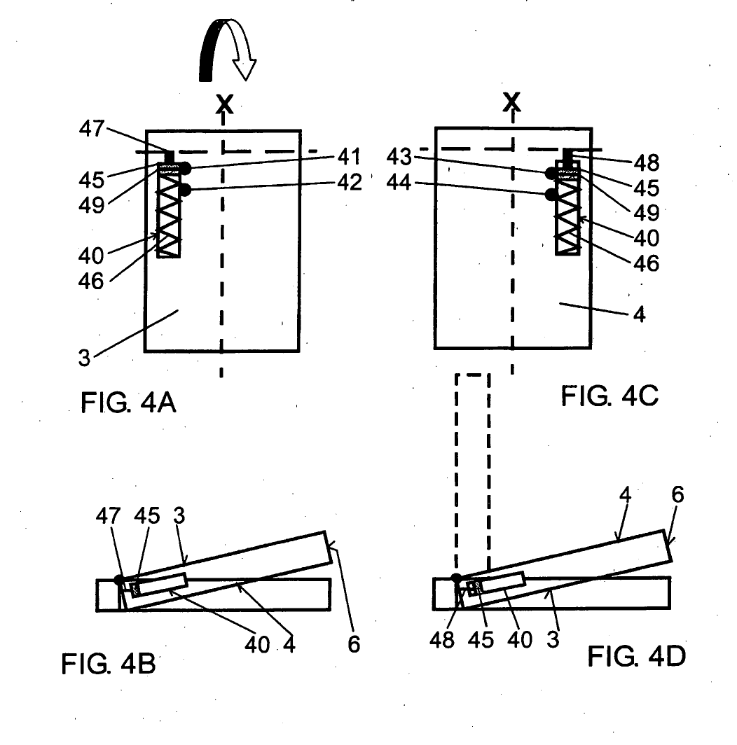

One method of turning off the not-required display, or of rotating the display, as described above, thus rendering it correctly for the viewer is illustrated in FIGS. 4A through 4D. A control switch 40 is located a certain distance from rotational axis X within case 7, which switch may, for example, be of cylindrical shape. This control switch 40 includes multiple positions sensors or switches 41, 42, 43, 44, and a slidable plunger pin 45 with a metal ring 49 and a spring 46. Plunger pin 45 is pressed by the spring against various-length cams 47, 48 which are actuated in response to the given top display 3 or 4. When the case is folded open or shut, the plunger pin is moved to the different positions, and sensors 41, 42, 43 and 44 are variously actuated as a function of the position and the fold-open angle of the inner case. In FIGS. 4A and 4C, only the sensors actuatable by the plunger pin for the respective position are shown.

In order to be able to read the information of display 6, inner case 7 is folded open to the position of the first detent, see FIG. 4B. As a result, plunger pin 45 moves outward a predetermined distance under the spring force of spring 46, depending on the opening angle of inner case 7 relative to outer case 2, and now no longer actuates sensor 42 but instead sensor 41. The software in the watch thereby recognizes that it is no longer only display 3 but also display 6 and the bottom display 4 which must be energized. At the same time, the previously nonvisible displays are set by the software to the current time; or the specific desired information, such as the stop watch, current date, etc., are displayed. In addition, the software recognizes, based on the specific actuated sensor, in which position the numbers and text should be displayed to as to be readable by the viewer.

When inner case 7 is folded completely open, all displayed information on the displays is preserved despite the fact that the plunger pin is no longer actuating sensors 41 through 44. When the watch is turned 180° and when it is folded down to the detent position of FIG. 4D, plunger pin 45 is pressed by spring 46 onto second cam 48 which is of a different length than cam 47. Sensor 43 is then actuated by this plunger pin position, and the text and numbers are rotated 180° by the software so as to be readable for the viewer.

When inner case 7 is now folded completely shut, plunger pin 45 is moved even further inward against sensor 44. Displays 3 and 6 are then de-energized by the software. The above variant can also be implemented using inductive measurement or other longitudinal or angular measurement methods.

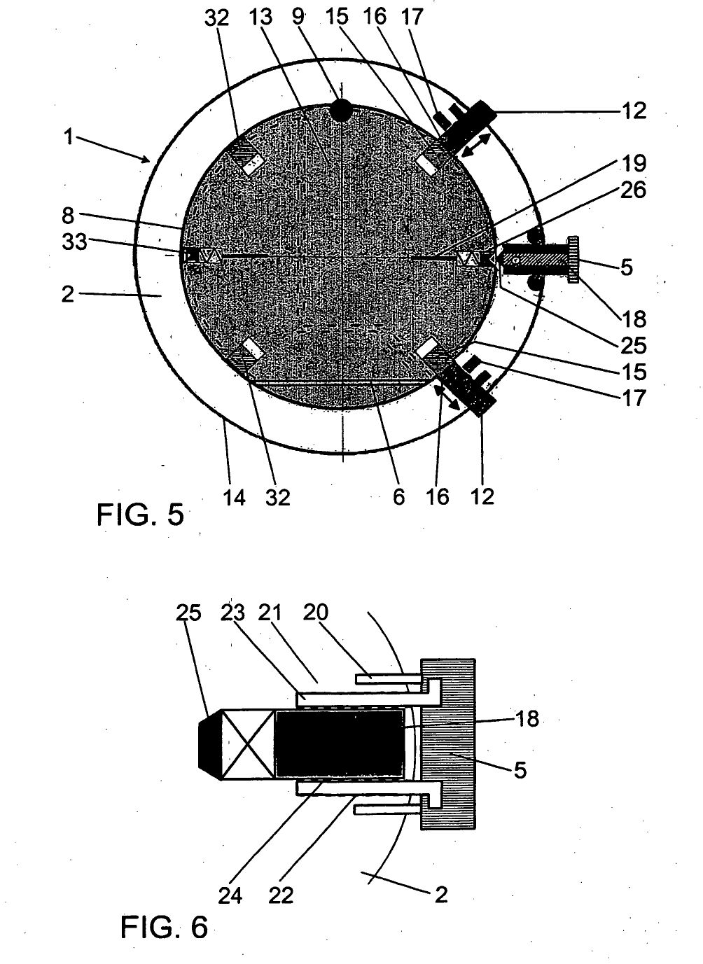

FIGS. 5 and 6 show details of crown 5 and push-buttons 12; push-button 12 is retained within outer case 2. When pressed in the direction of the case, the push-button is moved inward and actuates a momentary-contact switch 15 located within inner case 7, which momentary-contact switch then triggers the appropriate functions in watch movement 13. When once again released from outer case 2, push-button 12 is moved by a spring 16 into the original position; the same occurs for momentary-contact switch 15 within inner case 7. It is also possible, however, for a sensor 17 to be actuated by push-button 12 by which watch movement 13 or 14 is able to engage the lateral display. In FIG. 5, in contrast to the previously shown examples, the lateral display is shown in the upright position. This allows for the use of a conventional LCD display and facilitates reading the display; if desired, it is also possible to provide a special cover, not shown here, to prevent interference from sunlight. The cover can be generated, for example, by a horizontal circular display. Crown 5 is designed such that when unscrewed it engages the crown shaft 19 through a coupling pin 18, thereby enabling the crown shaft to be operated. To this end, the crown is connected through carrier pins 20 to a rotatable crown sleeve 21. This rotatable crown sleeve engages coupling pin 18 by means of a thread 22 of large pitch and an intermediate element 23, which is rotatably mounted in the crown, and a counter-rotating thread 24 on intermediate element 23. Rotating the crown thus moves the coupling pin in the direction of watch movement 13, thereby engaging a coupling gearing 26 of watch movement 13 through a coupling gearing 25, and thus engaging crown shaft 19. Based on the above-described design of the engagement mechanism, after establishing the coupling the crown shaft is able to be operated by turning the crown. In order to then release the coupling, the crown is screwed back into the case.

When the inner case is now rotated 180° so that the other display side 3 or 4 is on the top, push-buttons 12 no longer actuate momentary-contact switches 15 but instead momentary-contact switches 32 on the opposite side. These momentary-contact switches then interact with the top display side 3 or 4. Crown 5 also no longer engages coupling gearing 26 but instead coupling gearing 33 which also interacts with the now top display side.

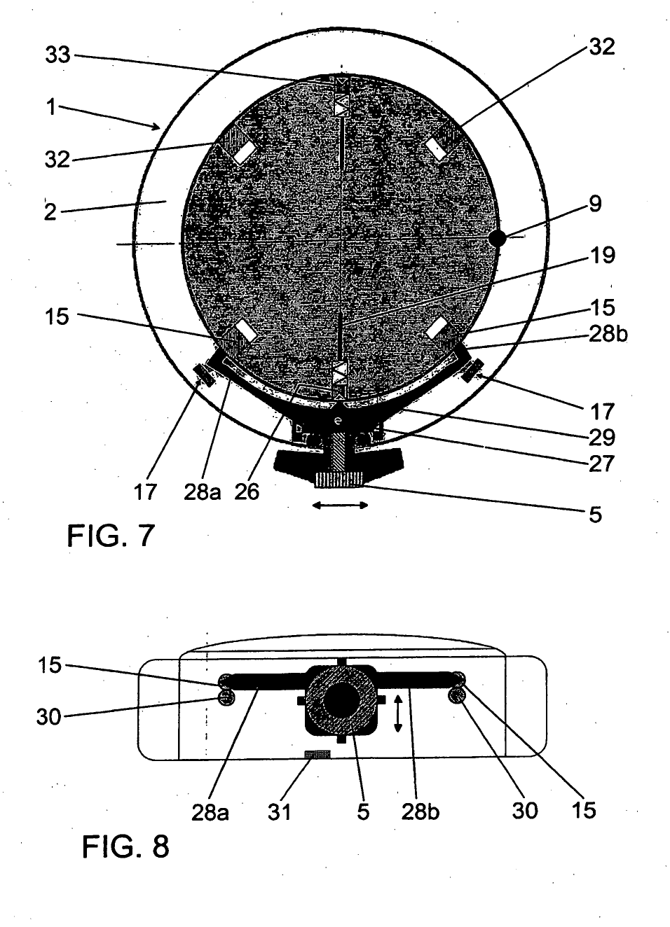

FIGS. 7 and 8 show another variant for operating the crown and push-buttons. The crown is connected to a rocker 29 located inside case 2. This rocker 29 is rotationally mounted on a pivot 27 so as to allow the rocker to be moved horizontally in response to an appropriate pressing action at the crown, thereby enabling momentary-contact switch 15 to be actuated by an arm 28a of rocker 29. When the crown is pressed in the opposite direction, the opposite momentary-contact switch 15 can be actuated by a second arm 28b of rocker 29. Actuating momentary-contact switch 15 enables watch functions to be triggered, for example, the stop watch, etc. After being actuated each time by the crown, rocker 29 is returned to the starting position by return elements, for example, springs.

Crown 5 can also be moved vertically relative to plane of the watch, i.e., the plane of the watch face. Rocker 29 follows this motion in another plane, by which action additional momentary-contact switches 30 can be operated by rocker 29. Pressing down the crown vertically in the direction of the base of the case additionally allows a sensor 31, for example, to be actuated.

Using multiple momentary-contact switches in different planes may allow momentary-contact switches 30 also to be actuated when the watch is in the folded-open state, without the necessity of moving rocker 29 vertically.

If the inner case is now rotated 180° so as to cause the other display side 3 or 4 to be on top, then it is no longer momentary-contact switches 15 but instead momentary-contact switches 32 on the opposite side, in FIG. 7, which are actuated by rocker 29. These momentary-contact switches then interact with the top display side 3 or 4. In addition, crown 5 no longer engages coupling gearing 26 but instead coupling gearing 33 which also no interacts with the top display side.

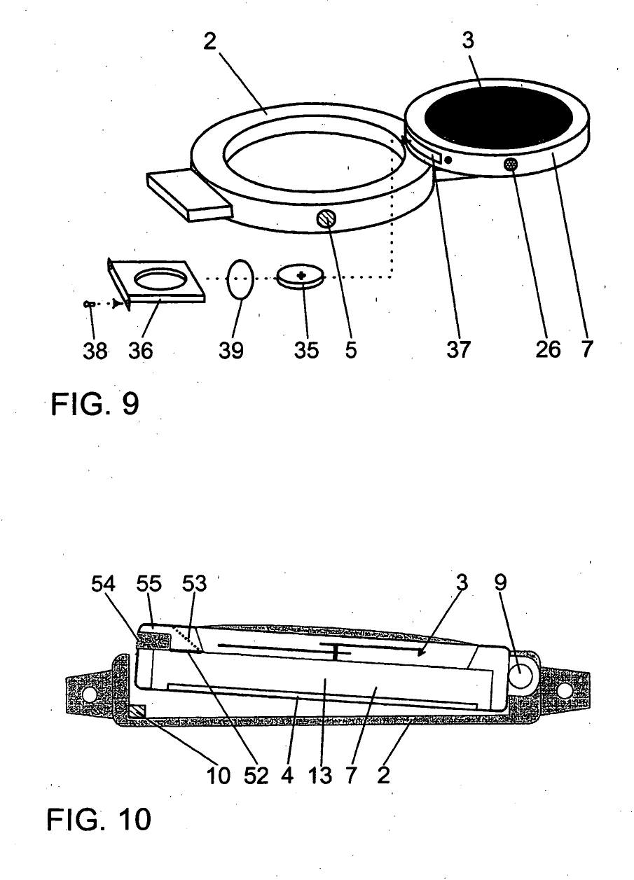

To supply power to the watch movement or the watches, a battery 35 can be inserted laterally into case 7 by means of a bracket 36 and retained there, for example, by screws 38, as shown in FIG. 9. A sealing element 39 secures the battery against external contamination as well as water or moisture. However, power can also be supplied by solar cells 34, as shown in FIG. 3, which are located on the crystals, and/or the display, and/or the outer case, and/or the strap. The required power can also be supplied by a generator located in the watch, whereby the generator is driven by the motion of the arm, and the excess power is stored in a rechargeable battery and/or capacitor. Power management of the watch is designed so that only the visible display or displays are energized, while the nonvisible display or displays are kept de-energized. In the chip associated with the de-energized display or de-energized displays, however, the time and auxiliary functions continue to be processed.

FIG. 10 provides a side view of a another embodiment of a lateral display on the watch. Here digital display 52 is oriented horizontally, the known approach for watches with a combination of digital and analog displays. This display is reflected by a mirror 53 and is visible through a covering crystal 54. For this purpose, of course, the information to be displayed must be rendered in digital display 52 in a mirror-reversed orientation to allow it to be read by the user after this reflection. The cover 55 enables the display to be read more easily since it precludes interference by, for example, extraneous light or sunlight.

The lateral display can be either straight or curved; and can be fabricated, for example, based on a curved LCD display, a polymer LCD display, or partial segments of conventional LCD displays.

It is of course understood that the invention is not limited to the embodiment illustrated and described here. The outer shape of the watch can take any form desired. If an electronic watch movement is employed, both display sides 3 and 4, or even lateral display 6 can be driven by one watch movement. If both an electronic and a mechanical watch movement are employed, both display sides 3 and 4 are driven separately by the two watch movements, while lateral display 6 can be driven by the electronic watch movement. One of displays 3 or 4 can also be employed not as display equipment but merely as ornamentation.

### List of Reference Notations

1 watch
2 first watch case
3 first watch face
4 second watch face
5 crown
6 display
7 second inner watch case
8 push-button, inner watch case
9 pivot
10 ejection element
11 locking element
12 push-button
13 watch movement
14 second watch movement
15 momentary-contact switch
16 spring
17 sensor
18 coupling pin
19 crown shaft
20 carrier pin
21 crown sleeve
22 crown sleeve thread
23 intermediate element
24 counter-rotating thread
25 coupling gearing, crown
26 coupling gearing, watch movement
27 pivot
28a arm
28b arm
29 rocker
30 momentary-contact switch
31 sensor
32 momentary-contact switch
33 coupling gearing, watch movement
34 solar cells
35 battery
36 bracket
37 location hole
38 screw
39 sealing element
40 control switch
41 position sensor
42 position sensor
43 position sensor
44 position sensor
45 plunger pin
46 spring
47 cam
48 cam
49 metal ring
52 digital display
53 mirror
54 crystal
55 cover
X axis of rotation

1. Watch (1), comprising a case (2, 7), at least one watch movement (13, 14) located in the case, and at least one display (3, 4) to display the time of day or other information, wherein at least one section of the watch (7) is movable, specifically, rotatable, wherein the case is composed of an outer case (2) and an inner case (7), and the inner case (7) is movably attached to the outer case, as a result of which a previously nonvisible side of the movable inner case (7) of the watch moves so as to lie on top,
characterized in
that the at least one display (3, 4) is located on the inner case, and that the inner case (7) is able to fold out of the outer case (2) so that at least one additional laterally oriented display (6) is visible.

2. Watch according to claim 1,
characterized in,
that the inner case (7) has two opposing horizontal displays (3, 4).

3. Watch according to one of the foregoing claims,
characterized in
that in the folded-shut state the then nonvisible display (3 or 4) and the nonvisible lateral display (6) are de-energized.

4. Watch according to one of the foregoing claims,
characterized in
that in the folded-open state the displays (3, 4, 6) visible to the viewer are rendered so as to be visible and readable for the viewer.

5. Watch according to claim 4,
characterized in
that when inner case (7) is reversed means are used to make rotatable by 180° the lateral display (6) and the display (3 or 4) which becomes visible when the watch is folded open.

6. Watch according to claims 1 through 5,
characterized in
that operating elements, specifically, a crown (5) and/or at least one push-button (12) are configured so as to allow adjustment of watch functions on the inner case (7).

7. Watch according to claims 1 through 5,
characterized in
that operating elements, specifically, a crown (5) and/or at least one push-button (12) are configured so as to allow adjustment of watch functions on the outer case (2).

8. Watch according to claim 7,
characterized in
that the crown includes elements (18, 20, 21, 22, 23, 24, 25) by which the crown engages a crown shaft (19) located within the inner case (7), and or the push-button (12) includes elements (16) by which a momentary-contact switch (15, 32) located within the inner case (7) can be actuated.

9. Watch according to one of the foregoing claims,
characterized in
the lateral display (6) is mechanically or electronically unlocked and is able to folded open by means of an ejection element (10).

10. Watch according to claim 9,
characterized in
that the electronic unlocking of lateral display (6) is performed automatically by an electronic signal, specifically, an alarm or by an incoming SMS signal.

11. Watch according to claims 9 or 10,
characterized in
that the ejection element is a spring.

12. Watch according to one of the foregoing claims,
characterized in
that the inner case (7) accommodates at least one watch movement.

13. Watch according to one of the foregoing claims,
characterized in
that a battery (35) supplies power to the at least one watch movement (13, 14) and/or multiple displays (3, 4, 6).

14. Watch according to one of the foregoing claims,
characterized in
that the battery (35) is laterally insertable into the inner case (7) and is attachable by retaining elements (36, 38).

15. Watch according to one of the foregoing claims,
characterized in
that solar cells (34) are located on the watch crystals, and/or at least one of the displays (3, 4), and/or outer case (2), and/or the inner case (7), and/or the strap.

16. Watch according to one of the foregoing claims,
characterized in
that the inner case (7) is lockable at different positions by detents which are located on the pivot (9), and/or between the outer case (2) and the inner case (7).
